(19) United States
(12) Patent Application Publication
(10) Pub. No.: US 2024/0185189 A1
(43) Pub. Date: Jun. 6, 2024

(54) METHOD FOR ORDERING THE VEHICLES OF A FLEET OF VEHICLES ACCORDING TO A MAINTENANCE NEED; ASSOCIATED COMPUTER PROGRAM AND COMPUTER SYSTEM

(71) Applicant: ALSTOM Holdings, ST OUEN SUR SEINE (FR)

(72) Inventors: Andrea STAINO, MAISONS LAFFITTE (FR); Nenad MIJATOVIC, PARIS (FR); Fabien KAY, SAINT-LEU-LA-FORET (FR); John ROBERTS, MAISONS LAFFITTE (FR); Julien CABOT, SAINT CLOUD (FR)

(21) Appl. No.: 18/491,108

(22) Filed: Oct. 20, 2023

(30) Foreign Application Priority Data
Oct. 24, 2022 (FR) 22 10996

(51) Int. Cl. G06Q 10/20

(52) U.S. Cl. CPC G06Q 10/20

(57) ABSTRACT

A method for ordering the vehicles of a fleet of vehicles according to a maintenance need includes determining a time series for each vehicle in the fleet. The time series includes, for each time step, an instantaneous value of at least one quantity of interest obtained from monitoring events acquired by a system for monitoring the vehicles of the fleet. The time series is analyzed over a predetermined time interval, considering the time series determined for all the vehicles of the fleet, and considering that at each time step, the state of a vehicle is either a “normal” state or an “abnormal” state. An optimal sequence of states over the predetermined time interval can thereby be obtained. A list of the vehicles of the fleet can be ordered according to the properties of bursts detected for each of the vehicles.

### CROSS-REFERENCE TO RELATED APPLICATION

This application claims priority to French Patent Application No. 2210996 filed on Oct. 24 2022, the disclosure of which including the specification, the drawings, and the claims is hereby incorporated by reference in its entirety.

### FIELD OF THE INVENTION

The field of the present invention relates to the maintenance of a fleet of vehicles, in particular railway vehicles, such as trains, subways, trams, etc.

### BACKGROUND OF THE INVENTION

Systems for monitoring potential failures of a railway vehicle are known, based on the generation of events during the operation of the vehicle. More precisely, the monitored vehicle is equipped with a plurality of sensors suitable for acquiring data which, once same are processed, can be used for generating characteristic events. An event is a new entry in a monitoring database. It is defined by a plurality of attributes, such as e.g. an identifier of the vehicle, an identifier of the event, an instant of occurrence of the event, the type to which the event belongs, and different values characterizing the event (which could depend on the type to which the event belongs).

Currently, the events generated for a vehicle are analyzed by maintenance operators in order to carry out a diagnosis on the condition of the vehicle and determine if it is necessary to carry out a maintenance operation on the vehicle and the nature of the maintenance operation: simple inspection or replacement of any faulty (or about to fail) component of the railway vehicle concerned.

However, such monitoring systems generate thousands of events, every day and for every vehicle in a fleet.

Such a mass of information is difficult to analyze by an operator. Such an analysis remains complex, in particular for establishing significant correlations between events. The analysis thus requires a significant investment in terms of working time and costs.

Moreover, it is practically impossible for an operator to compare the vehicles of a fleet with each other, for determining which of the vehicles is in urgent need of maintenance, in order to carry out the required maintenance operations on the vehicle as a priority over another. Currently, the choice to inspect one vehicle over another is essentially an empirical decision made by the maintenance operator.

Therefore, it would be interesting to be able to quickly and simply identify the vehicle(s) of a fleet which have a priority need of maintenance, if only to optimize maintenance tasks and limit the time during which an item of equipment cannot be used.

### SUMMARY OF THE INVENTION

The goal of the present invention is in particular to address such a need.

For this purpose, the subject matter of the invention relates to a computer- implemented method for ordering the vehicles of a fleet of vehicles according to a need for maintenance, characterized in that the method includes the steps of: for each vehicle in the fleet, determining a time series, the time series including, for each time step, an instantaneous value of at least one quantity of interest obtained from monitoring events acquired by means of a system for monitoring vehicles of the fleet of vehicles; analyzing, over a predetermined time interval, the time series, taking into account the time series determined for all vehicles of the fleet of vehicles, considering that at each time step, the state of a vehicle is either a “normal” state or an “abnormal” state requiring maintenance, so as to obtain an optimal sequence of states over the predetermined time interval; and detecting, if appropriate, the presence of one or a plurality of bursts in the optimal sequence of states, and then ordering a list of the vehicles of the fleet of vehicles according to the properties of the bursts detected for each of the vehicles.

According to particular embodiments, the method includes one or more of the following features, taken individually or according to all technically possible combinations:
the quantity of interest is the total number of events or the total number of events of a particular type affecting the vehicle considered, acquired during a reference time window.
analyzing the time series includes an optimization of a cost function, associating a likelihood function and, preferentially, a transition function, so as to determine an instantaneous probability for each time step.
the instantaneous probability for a time step is compared with a reference probability calculated from the quantities of interest of all the vehicles of the fleet of vehicles, so as to determine the optimal state wherein the vehicle considered is located at the time step considered.
the presence of bursts in the optimal sequence of states consists in determining a number of consecutive time steps the vehicle spends in the “abnormal” state in the optimal sequence of states and, when the number of time steps is greater than a predetermined threshold, considering same as a burst.
a burst is characterized by a duration and/or an intensity and ordering the list of vehicles of the fleet of vehicles according to the properties of the bursts detected for each vehicle is carried out depending on the duration and/or the intensity of said bursts.
the vehicle is a railway vehicle, such as a train, a subway, or a tram.

A further subject matter of the invention is a computer program product including software instructions which, when executed by a computer, implement the preceding method.

A further subject matter of the invention is a computer system, characterized in same is suitable for implementing the preceding method, the computer system being suitable for accessing the content of a monitoring database, for reading the monitoring events acquired by a monitoring system.

Preferentially, the system includes: a module for determining a time series of a quantity of interest; a module for analyzing the time series of a quantity of interest, for determining an optimal sequence of states; a module for detecting bursts in the optimal sequence of states; and, a module for scheduling the vehicles of a fleet of vehicles according to the properties of the bursts detected.

### BRIEF DESCRIPTION OF THE DRAWINGS

The invention and the advantages of the invention will better understood upon reading the following detailed description of the different embodiments of the invention, given only as examples and not limited to, the description being made with reference to the enclosed drawings, wherein:

FIG. 1 is a schematic representation of a computer system for the implementation of the method according to the invention; and,

FIG. 2 is a block representation of a preferred embodiment of the scheduling method according to the invention.

### DETAILED DESCRIPTION OF THE PREFERRED EMBODIMENTS

The method according to the invention makes it possible to automatically order the trains of a fleet of trains according to a need for maintenance.

A fleet of trains consists of a plurality of trains which are similar or even identical to each other and which are put into circulation on a network in an essentially interchangeable way. In other words, the question of ordering the trains of a fleet with respect to each other according to a need for maintenance makes sense, since the different trains have comparable structures (and hence the wear thereof and potential failures thereof) and in the use thereof (and thus the operating conditions thereof).

The method according to the invention is based on the detection of bursts by analyzing a time series of a quantity of interest derived from events generated by a monitoring system of the prior art.

In the context of the time series analysis of a quantity, burst detection is a technique for identifying the values of such a quantity, which show a sharp increase over a limited period of time compared to a base level.

Many burst detection algorithms are known, in particular in signal processing applications. In general, a burst detection algorithm identifies periods of time (or bursts) during which a target value is unusually frequent.

Burst detection algorithms can be suitable for discrete data streams, as is the case for events generated by a system for monitoring a fleet of trains. Hereinafter, the embodiment which is presented in detail implements a burst detection algorithm based on a logarithmic maximum likelihood.

According to the invention, the detection of bursts for a particular train is performed by determining the base level from the events generated by the monitoring system for all the trains of the fleet.

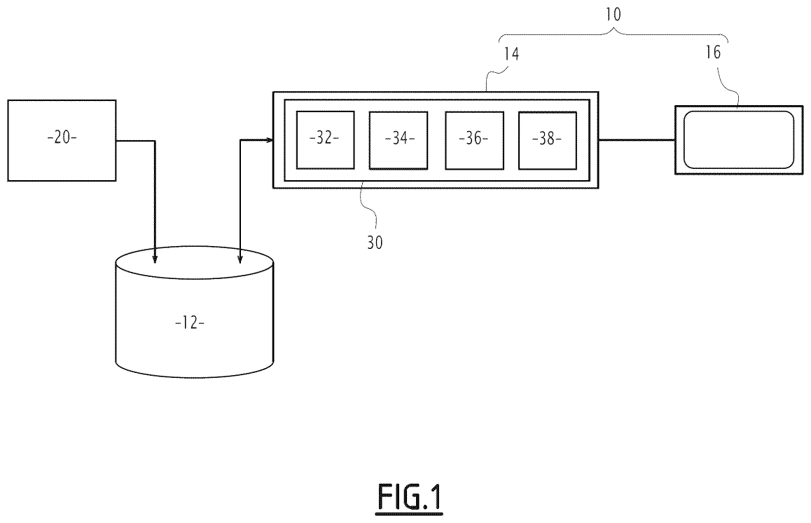

FIG. 1 shows a computer system 10 for implementing the method according to the invention.

Same includes a monitoring database 12 collecting the events generated by a monitoring system 20 for the trains of the fleet.

The computer system 10 includes a computer 14 including means of computing such as a processor, and means of storage, such as a memory. The means of storage store the instructions of computer programs, in particular a program 30 the execution of which is used for implementing the method according to the invention.

The program 30 can be broken down into modules, more particularly a module 32 for determining a time series of a quantity of interest, a time series analysis module 34, a module 36 for detecting bursts, and a module 38 for scheduling the trains of the fleet.

The computer system 10 advantageously includes a man-machine interface 16, e.g. a tablet, for displaying to the invention, to a maintenance operator, the results of the implementation of the method according.

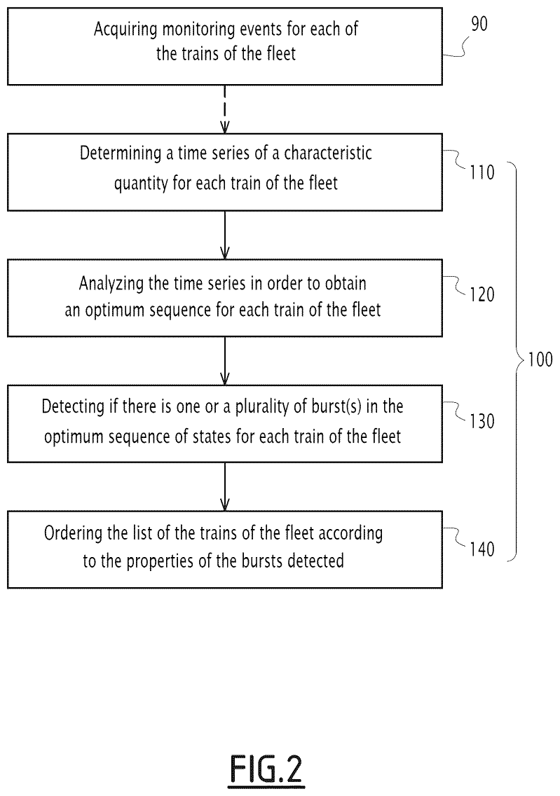

Referring to FIG. 2, a preferred embodiment of a method for ordering the trains of a fleet of trains according to a maintenance need, is presented.

The method 100 is implemented independently of a prior step 90 of acquisition of events.

The method 100 as such includes a step 110 of determining a time series of a quantity of interest or of characteristic quantity (such step corresponding to the execution of the module 32), a step 120 of analysis of a time series (such step corresponding to the execution of the module 34), a step 130 of detecting bursts (such step corresponding to the execution of the module 36) and a step 140 of scheduling the trains of the fleet (such step corresponding to the execution of the module 38).

### The Acquisition Step 90

Such step, which is prior to the implementation of the process according to the invention, is carried out according to the prior art.

The step is carried out by the monitoring system 20.

The step consists of acquiring monitoring data for each train of the fleet and of producing events from the acquired data.

The data are delivered by sensors equipping each train.

Events are associated with a particular train. The events are dated. For example, the time step chosen for the dating of events is the time step of a day.

The events are recorded in the monitoring database 12.

It should be noted that a high number of occurrences of an event could be due to an actual failure of the monitored equipment (the monitoring system can then continue to report the failure until the failure is repaired). However, a high number of occurrences could also be due to an error in the design of the monitoring system as such, in particular the modeling of the failure the system uses for generating monitoring events (and then the monitoring system signals the event several times over time).

### The Step 110 of Determining a Time Series of a Quantity of Interest

The purpose of step 110 is to construct, for each train, a time series of a quantity of interest, from the events contained in the monitoring database 12.

The quantity of interest is any time variable developed from all or a part of the monitoring events associated with a train and making it possible, by aggregating the monitoring events, to quantify a need for maintenance at each time step.

For example, a time window corresponding e.g. to a week of operation of a train, is first defined.

The quantity of interest is then e.g. the total number of monitoring events generated for the train considered within the time window. The quantity of interest thus calculated is dated e.g. with the last day of the time window used.

It is sufficient to repeat such operation by incrementing the time window of the chosen time step (herein the day), to calculate a quantity of interest for each day of operation of a train.

The time series for a train is then made up of the sequence of values of the quantity of interest for said train.

Such a time series is obtained for each of the trains of the fleet.

In a variant, instead of the cumulative number of events, the quantity of interest could correspond to the cumulative number of events belonging to a particular type (i.e. associated with a specific fault or a component of the train). In another variant, instead of analyzing only a time series of a quantity of interest, it could be chosen to calculate different quantities of interest and to follow each of the quantities over time.

### The Step 120 of Analyzing a Time Series

For each train of the fleet, such step consists in analyzing the time series of the quantity of interest obtained in step 110 by applying a burst detection algorithm, and then quantifying the need for maintenance of the train considered as a function of the bursts detected.

The step takes into account not only the time series associated with the train considered, but also the time series associated with the other trains of the fleet.

The burst detection algorithm more particularly used in the present embodiment is based on the model that at each time step a train can only be in two possible states, a nominal operating state (“normal state” hereinafter) and an operating state requiring maintenance (“abnormal state” hereinafter), respectively.

More specifically, assuming that the events follow a binomial distribution when the train is in the normal state and a binomial distribution (identical, in order to simplify the present description) when the train is in the abnormal state, the burst detection algorithm aims to determine the sequence of states which corresponds best to the observations consisting of the values of the time series of the quantity of interest over the considered time interval.

Let us consider e.g. a time interval of one week, subdivided by time steps of one day. Each time step of the interval is indexed by the integer t between 1 and T, where [T] is the maximum number of time steps of the interval of interest (herein T is equal to 7).

Consider a fleet of N trains. Each train is indexed by an integer j between 1 and N.

The daily value of the characteristic quantity for train j on day t is denoted by: gⱼ(t)

The daily value of the total characteristic quantity for all the trains of the fleet on day t is given by: g_{F}(t)=Σⱼ₌₁^{N}gⱼ(t)

The integrated value of the characteristic quantity for the train j over the time interval is given by: Gⱼ=Σₜ₌₁^{T}gⱼ(t)

The integrated value of the total characteristic quantity for all the trains of the fleet over the time interval is given by: G_{F}(t)=Σⱼ₌₁^{N}g_{F}(t)

The probability of the base level for train j, or reference probability, is defined by: pⱼ^{ref}=Gⱼ/G_{F}

Such reference probability is associated with the normal state for train j. Same corresponds to the events affecting train j with respect to all of the events affecting the trains of the fleet, over the time interval considered.

The associated burst probability for the train j is then defined by: pⱼ^{burst}=α·pⱼ^{ref}, where α is a constant of proportionality.

Such burst probability is associated with the abnormal state for the train j.

It is then necessary to calculate a sequence of states s(t) over the considered time interval, which is compatible with the characteristic values gⱼ(t) and g_{F}(t) for the train j.

To this end, a statistical criterion is chosen. For example, in the present embodiment, the statistical criterion chosen is based on a cost function associating a logarithmic likelihood function, advantageously combined with a transition function.

The instantaneous likelihood function associated with the state s(t) at time t (also denoted by s) for the train j is the binomial likelihood function [symbol] _{s,j}(t):

$$\\ {ℒ}_{s , j} ( t ) = {[ ( \begin{matrix}{g}_{F} ( t ) \\ {g}_{j} ( t )\end{matrix} ) \cdot {p}_{j}^{{}^{} s} ]}^{{g}_{j} ( t )} \cdot {[ ( 1 - {p}_{j}^{{}^{} s} ) ]}^{{g}_{F} ( t ) - {g}_{j} ( t )}$$

For numerical reasons, the logarithm of [symbol] _{s,j}(t) is to be minimized over the considered time interval. In order to evaluate the likelihood of the normal state (s=“normal”), the probability pⱼ^{s} is taken equal to pⱼ^{ref}. The likelihood of the abnormal state (s=“abnormal”) is evaluated by taking pⱼ^{s} equal to pⱼ^{burst}.

The transition function H_{s,j}^{s′}(t) from the state s at instant t to the state s′ at the next instant t+1 is used for associating a cost with a change of state.

Preferentially, since, by definition, the normal state is the expected state of the train and the abnormal state is an “exceptional” state, the transition function is non-zero only if there is a change of state and the transition takes place from the normal state to the abnormal state.

It is conceivable that the transition function is proportional to T, to make T comparable to the likelihood term in the optimization process when T increases (i.e. when the time interval increases).

Thereby, the instantaneous criterion to minimize is the following:

fⱼ(t)=−In ( [symbol] _{s,j}(t))+H_{s,j}^{s′}(t)

Over the time interval, the criterion to be minimized becomes:

$$\\ {F}_{j} = {\sum }_{t = 1}^{T} {f}_{j} ( t )$$

The optimal sequence of states s(t) of the train j, i.e. the sequence of states (“normal” or “abnormal”) of the train j which best explains the observation according to the binomial model, is thus the sequence which minimizes the cost function for all the time steps of the considered time interval.

The optimum sequence is determined e.g. using an optimization by a “greedy” algorithm, known to a person skilled in the art.

### Step 130 of Detecting Bursts

The optimum sequence of states is finally analyzed to isolate any bursts therein. A burst is then characterized by a minimum number of consecutive time steps in the abnormal state. Such threshold number is predefined. Same can be chosen to be equal to one, a burst being detected as soon as the train is in the abnormal state.

In addition to the duration thereof, a burst can be characterized by an intensity. The intensity of a burst is e.g. given by the sum of the values of the cost function fⱼ(t) over the time step(s) associated with the burst.

### The Scheduling Step 140

Once the previous steps have been completed for each train, the way to order the trains of the fleet among with respect to each other depends on the quantity of interest.

Considering, like in the previous example, the cumulative number of daily events, the trains can be classified in descending order of duration of bursts detected for each train over the time interval considered. If two bursts have the same duration, then the trains are classified by decreasing intensity of the bursts.

On the other hand, if the number of daily events belonging to a particular type is considered, then the bursts are classified by intensity (knowing that the intensity takes into account the duration of the burst in a certain way).

Once the trains in the fleet are ordered by order of priority, only the identifiers of the first X trains (e.g., X=3) are displayed on the interface 16.

Advantageously, by selecting the identifier of a train, the operator accesses the most recurrent Y events (e.g., Y=5) affecting that train

### Benefits

The present method helps maintenance operators to select the priority train for maintenance in a quick and efficient way.

What is relevant for the classification of trains with respect to each other is not the number of occurrences of events as such, but rather a significant change in the proportion of events generated by a train compared to the rest of the fleet, in a certain period of time and, if appropriate, for a certain type of event.

If an unusual and abrupt increase occurs for a particular train (in the total number of events, or only for one type of event), then it may be considered that, for some reason, the behavior of that train is altered. It is important to report the above situation automatically because same can be symptomatic of something abnormal which should be rectified as soon as possible.

What is claimed is:

1. A computer-implemented method for ordering the vehicles of a fleet of vehicles according to a maintenance need, wherein the method comprising:
for each vehicle in the fleet of vehicles:
determining a time series, the time series including, for each time step, an instantaneous value of at least one quantity of interest obtained from monitoring events, the monitoring events being acquired by a monitoring system for monitoring the vehicles of the fleet of vehicles;
analyzing, over a predetermined time interval, the time series, taking into account the time series determined for all the vehicles of the fleet of vehicles, by considering that, at each time step, a state of the vehicle is either a “normal” state or an “abnormal” state, the “abnormal” state requiring maintenance, so as to obtain an optimal sequence of states over the predetermined time interval; and
detecting a presence, if any, of one or several burst(s) in the optimal sequence of states, then
ordering a list of the vehicles of the fleet of vehicles according to properties of the burst(s) detected for each vehicle.

2. The method according to claim 1, wherein the quantity of interest is the total number of monitoring events or the total number of monitoring events of a particular type affecting the vehicle during a reference time window.

3. The method according to claim 1, wherein analyzing the time series includes an optimization of a cost function, the cost function being associated a likelihood function and preferentially a transition function, so as to determine an instantaneous probability for each time step.

4. The method according to claim 3, wherein the instantaneous probability for each time step is compared with a reference probability calculated from the quantities of interest of all vehicles of the fleet of vehicles, to determine an optimal state of the vehicle at each time step.

5. The method according to claim 1, wherein detecting the presence of one or several burst(s) in the optimal sequence of states consists of determining a number of consecutive time steps the vehicle is in the “abnormal” state in the optimal sequence of states, and, when the number of consecutive time steps is greater than a predetermined threshold, considering the consecutive time steps as a burst.

6. The method according to claim 1, wherein each burst is characterized by a duration and/or an intensity, and wherein ordering the list of vehicles of the fleet of vehicles according to the properties of the burst(s) detected for each vehicle of the fleet of vehicles is based on the duration and/or the intensity of each burst.

7. The method according to claim 1, wherein the vehicle is a railway vehicle.

8. A computer program including software instructions which, when executed by a computer, implement the method according to claim 1.

9. A computer system comprising hardware and software for implementing a method according to claim 1, the computer system accessing the contents of a monitoring database for reading the monitoring events acquired by the monitoring system.

10. The computer system according to claim 9, further comprising:
a module for determining a time series of a quantity of interest for each vehicle of a fleet of vehicles;
a module for analyzing the time series of a quantity of interest, for determining an optimal sequence of states;
a module for detecting, if any, one or several burst(s) in the optimal sequence of states; and
a module for scheduling the vehicles of a fleet of vehicles according to properties of the bursts detected.

11. The computer system according to claim 7, wherein the vehicle is a train, a subway or a tram.
